(19) United States
(12) Patent Application Publication
(10) Pub. No.: US 2006/0086016 A1
(43) Pub. Date: Apr. 27, 2006

(54) Device for fixing lines

(76) Inventors: Anthony Cornell, Herrenberg (DE); Holger Eissler, Holzgerlingen (DE); Gerd Felber, Sindelfingen (DE); Achim Koehler, Leonberg (DE)

Correspondence Address: KENYON & KENYON LLP, ONE BROADWAY, NEW YORK, NY, 10004, US

(21) Appl. No.: 11/215,452

(22) Filed: Aug. 29, 2005

(30) Foreign Application Priority Data
Aug. 27, 2004 (DE) 10 2004 041 431.9

(51) Int. Cl. G09F 7/00

(52) U.S. Cl. 40/209

(57) ABSTRACT

A device for fixing lines and/or pipelines, cables, cable sleeves and/or small components is fixed to the underside of a motor vehicle with the aid of at least one cover plate. The device may be designed and arranged such that savings may be made on fixing elements. At least one holder may be provided for the purpose of accommodating the pipelines, cables, cable sleeves and/or small components and connected to a body part of a motor vehicle between the underside of the motor vehicle and the cover plate, the cover plate and the holder being fitted to the body part with the aid of a fixing element.

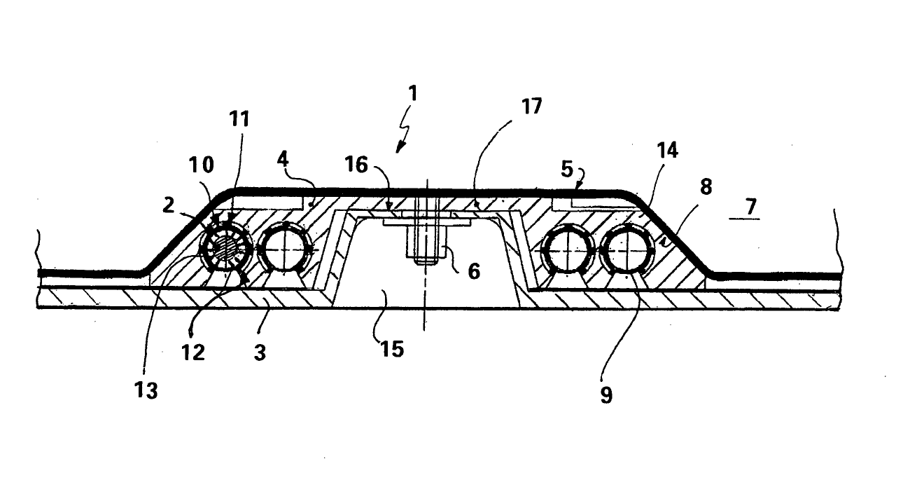

### CROSS-REFERENCE TO RELATED APPLICATIONS

The present application claims priority to Application No. 10 2004 041 431.9, filed in the Federal Republic of Germany on Aug. 27, 2004, which is expressly incorporated herein in its entirety by reference thereto.

### FIELD OF THE INVENTION

The present invention relates to a device for fixing lines and/or pipelines, cables, cable sleeves and/or small components which is fixed to the underside of a motor vehicle with the aid of at least one cover plate.

### BACKGROUND INFORMATION

A conventional cover in the form of a carrier plate (see, e.g., German Published Patent Application No. 101 32 969) can be fixed to the underbody of a motor vehicle and has at least one component to be arranged on the underbody and/or a component group. It is an intention to create an economical solution and cost-effective installation of components to be arranged on the underbody of a motor vehicle. For this purpose, two or more components and/or component groups to be arranged on the underbody of the motor vehicle are arranged on or at the cover plate in the form of a carrier plate and a preassembly plate and/or such that they are integrated in the cover plate. The components and/or component groups are fixed to the cover plate using numerous individual fixing elements. The cover plate can be fixed, with the components and/or component groups, to the underbody using numerous fixing elements. Installation is therefore time-consuming.

### SUMMARY

An example embodiment of the present invention may provide a device for fixing pipelines or cables such that it may be possible to manage with as few fixing elements as possible.

According to an example embodiment of the present invention, at least one holder for the purpose of accommodating the pipelines, cables, cable sleeves and/or small components is connected to a body part of a motor vehicle between the underside of the motor vehicle and the cover plate, the cover plate and the holder being fitted to the body part with the aid of a fixing element. This may make it possible for the holder to be connected to the body part of the vehicle using a single connection element, in a simple manner and in a short period of time with the aid of the cover plate. In addition, it may be possible to dispense with a securing clip for the pipelines in the region of the cover plate since the cover plate may provide sufficient protection for the pipelines, cables, cable sleeves and/or small components. The cover plate may also be underbody cladding.

One or more holders, which are covered with the aid of the cover plate, may be provided on the underside of the motor vehicle. By this, the pipelines or cables may be protected against contamination and damage.

The cover plate and the holder may be fixed to a body part of the motor vehicle together, with the aid of a single connection element. Since the cover plate and the holder may be fixed to the body part via a single connection element, savings may be made on fixing elements and the time required for installation may be shortened.

The holder may be matched to the outer contour of a cutout provided in the body part. This may make it possible for the holder to be accommodated on the body part in a space-saving manner.

The cover plate may cover the entire cutout accommodating the holder such that no parts protrude.

Provision may be made for one or more flexible clamping elements to be provided in the holder which accommodate the pipelines and are open towards one side for the purpose of accommodating the pipeline or the cable. The clamping elements may prevent structure-borne sound from being transmitted to the body parts and may be suitable for rapid and simple installation of the pipeline or the cables or other parts.

The clamping elements may include a circular arc-shaped segment which is accommodated in the cutout provided in the holder via one or more webs such that an air gap is formed between the outer circumference of the segment and the holder. The circular arc-shaped segments may make it easier to clip the pipeline or the cables or tubes into the holders.

The segment may have one or more spacer webs on its inside, it being possible for the outside of the pipelines or the cable to be positioned against the spacer webs. By this, transmission of structure-borne sound to the motor vehicle may be prevented.

The holder may have a right-hand and left-hand supporting part having a connecting web, the connection element for the purpose of connecting the cover plate and the holder being provided between the two supporting parts.

The cover plate may have a cup-shaped depression having a planar bearing face which may be pressed against the surface of the holder. This may make it possible to achieve a planar surface and to prevent the clamping elements from protruding on the surface of the cover plate and being damaged by the impact of stones or by contamination.

The clamping element may be made from an elastomeric material and may surround the pipelines in an interlocking manner.

According to an example embodiment of the present inventions, a device for fixing at least one of (a) lines, (b) pipelines, (c) cables, (d) cable sleeves and (e) small components fixed to an underside of a motor vehicle includes: at least one cover plate; at least one holder adapted to accommodate the at least one of (a) the lines, (b) the pipelines, (c) the cables, (d) the cable sleeves and (e) the small components connected to a body part of the motor vehicle between the underside of the motor vehicle and the cover plate; and a fixing element, the cover plate and the holder fitted to the body part by the fixing element.

The cover plate may be adapted to cover the at least one holder on the underside of the motor vehicle.

The fixing element may include a single connection element adpated to fix the cover plate and the holder together to the body part of the motor vehicle.

The holder may be matched to an outer contour of a cutout arranged in the body part.

The cover plate may be adapted to cover an entire cutout accommodating the holder.

The holder may include at least one flexible clamp element. The flexible clamp element may be open toward one side and may be adapted to accommodate the at least one of the at least one of (a) the lines, (b) the pipelines, (c) the cables, (d) the cable sleeves and (e) the small components.

The clamp element may include a circular arc-shaped segment accommodated in a cutout arranged in the holder by at least one web, and an air gap may be formed between an outer circumference of the segment and the holder.

An inside of the segment may include at least one spacer web, and the at least one of (a) the lines, (b) the pipelines, (c) the cables, (d) the cable sleeves and (e) the small components may be positionable against the spacer web.

The holder may include a right-hand support part, a left-hand support part and a connecting web, and the fixing element may be arranged between the right-hand support part and the left-hand support part.

The cover plate may include a cup-shaped depression having a planar bearing face pressable against a surface of the holder.

The clamp element may be made from an elastomeric material and may be adapted to surround the at least one of (a) the lines, (b) the pipelines, (c) the cables, (d) the cable sleeves and (e) the small components in an interlocking manner.

According to an example embodiment of the present invention, a device for fixing at least one of (a) lines, (b) pipelines, (c) cables, (d) cable sleeves and (e) small components fixed to an underside of a motor vehicle includes: at least one cover plate means; at least one holder means for accommodating the at least one of (a) the lines, (b) the pipelines, (c) the cables, (d) the cable sleeves and (e) the small components connected to a body part of the motor vehicle between the underside of the motor vehicle and the cover plate means; and fixing means for fixing the cover plate and the holder to the body part.

Further aspects and details hereof are more fully described below with reference to the appended FIGURE.

### BRIEF DESCRIPTION OF THE DRAWING

The FIGURE is a schematic view of a device according to an example embodiment of the present invention.

### DETAILED DESCRIPTION

The FIGURE is a schematic view of a device 1 for fixing pipelines or cables, cable sleeves and/or small components 2 which may be used, e.g., in motor vehicles. The device 1 for fixing pipelines or cables 2 or other components includes a cover plate 3 and at least one holder 4. The cover plate 3 is the underbody cladding in the exemplary embodiment. The holder 4 has a right-hand and left-hand supporting part 14 which are fixedly connected to one another via a connecting web 17. The supporting parts 14 connected to the connecting web 17 are bent back slightly such that they may be inserted as an overall device into a cutout 8 which is V-shaped or has another configuration and is provided in a body part 7 and such that they may be connected to an underside 5 of the body part 7 of the motor vehicle via a connection element 6. The connection element 6 may be a rivet or a screw connection which passes through an opening provided in the cover plate 3 and in the holder 4 and is screwed or riveted to the underside of the body part 7. The holder 4 is matched to the outer contour of the cutout 8 provided in the body part 7.

The cover plate 3 may abe arranged such that it covers all of the downwardly pointing opening of the cutout 8 and, as a result, protects the pipelines or cables 2 from damage.

The holder 4 includes a right-hand and left-hand supporting part 14 which are arranged on a connecting web 17. The connection element 6 for the purpose of connecting the cover plate 3 and the holder 4 is provided between the two supporting parts 14 and, as already mentioned, is fixed to the body part 7.

The holder 4 may be replaced by another holder which may be made from an elastomeric material, for example, from rubber or from plastic, the clamping elements 9 surrounding the pipelines 2 in an interlocking manner without an intermediate space between the surface of the clamping elements 9 and the surface of the pipelines 2.

One or more flexible clamping elements or clips 9 are provided in the holder 4 which accommodate the pipelines or cables 2 and are open towards one side for the purpose of accommodating the pipelines, cables or the cable sleeves and/or small components 2 such that the pipelines, cables or cable sleeves and/or small components 2 may be accommodated and secured in the clamping elements 9.

The clamping elements 9 include a circular arc-shaped segment 10 which is accommodated in the cutout 8 provided in the holder 4 via one or more webs 11 such that an air gap is formed between the outer circumference of the segment 10. The segment 10 has one or more spacer webs 13 on its inside 12, it being possible for the outside of the pipelines or the cable 2 to be positioned against said spacer webs 13.

The cover plate 3 has a cup-shaped depression 15 having a planar bearing face 16 which may be pressed against the surface of the holder 4.

What is claimed is:

1. A device for fixing at least one of (a) lines, (b) pipelines, (c) cables, (d) cable sleeves and (e) small components fixed to an underside of a motor vehicle, comprising:
at least one cover plate;
at least one holder adapted to accommodate the at least one of (a) the lines, (b) the pipelines, (c) the cables, (d) the cable sleeves and (e) the small components connected to a body part of the motor vehicle between the underside of the motor vehicle and the cover plate; and
a fixing element, the cover plate and the holder fitted to the body part by the fixing element.

2. The device according to claim 1, wherein the cover plate is adapted to cover the at least one holder on the underside of the motor vehicle.

3. The device according to claim 1, wherein the fixing element includes a single connection element adpated to fix the cover plate and the holder together to the body part of the motor vehicle.

4. The device according to claim 1, wherein the holder is matched to an outer contour of a cutout arranged in the body part.

5. The device according to claim 4, wherien the cover plate is adapted to cover an entire cutout accommodating the holder.

6. The device according to claim 1, whreein the holder includes at least one flexible clamp element, the flexible clamp element open toward one side and adapted to accommodate the at least one of the at least one of (a) the lines, (b) the pipelines, (c) the cables, (d) the cable sleeves and (e) the small components.

7. The device according to claim 6, wherein the clamp element includes a circular arc-shaped segment accommodated in a cutout arranged in the holder by at least one web, an air gap formed between an outer circumference of the segment and the holder.

8. The device according to claim 7, wherein an inside of the segment includes at least one spacer web, the at least one of (a) the lines, (b) the pipelines, (c) the cables, (d) the cable sleeves and (e) the small components positionable against the spacer web.

9. The device according to claim 1, wherein the holder includes a right-hand support part, a left-hand support part and a connecting web, the fixing element arranged between the right-hand support part and the left-hand support part.

10. The device according to claim 1, wherein the cover plate includes a cup-shaped depression having a planar bearing face pressable against a surface of the holder.

11. The device according to claim 6, wherein the clamp element is made from an elastomeric material and is adapted to surround the at least one of (a) the lines, (b) the pipelines, (c) the cables, (d) the cable sleeves and (e) the small components in an interlocking manner.

12. A device for fixing at least one of (a) lines, (b) pipelines, (c) cables, (d) cable sleeves and (e) small components fixed to an underside of a motor vehicle, comprising:
at least one cover plate means;
at least one holder means for accommodating the at least one of (a) the lines, (b) the pipelines, (c) the cables, (d) the cable sleeves and (e) the small components connected to a body part of the motor vehicle between the underside of the motor vehicle and the cover plate means; and
fixing means for fixing the cover plate and the holder to the body part.
